(19) United States
(12) Patent Application Publication
(10) Pub. No.: US 2003/0187656 A1
(43) Pub. Date: Oct. 2, 2003

(54) Method for the computer-supported transformation of structured documents

(76) Inventors: Stuart Goose, Princeton, NJ (US); Timothy Miller, Muenchen (DE); Stefan Holz, Muenchen (DE); Wei-Kwan Vincent Su, Princeton, NJ (US)

Correspondence Address: BELL, BOYD & LLOYD, LLC, P. O. BOX 1135, CHICAGO, IL, 60690-1135, US

(21) Appl. No.: 10/037,979

(22) Filed: Dec. 20, 2001

(51) Int. Cl. G10L 21/00

(52) U.S. Cl. 704/270.1

(57) ABSTRACT

A method for the computer-supported transformation of structured documents into a modified, structured document which can be read and/or processed via an IVR browser. Here, an analysis of a source code which forms the structured document is carried out with a transformation of the structured document into a modified, structured document using a source code which can be read by the IVR browser, a modification of the source code of the structured document being carried out in order to define a speech-based menu structure. In the case of cross-references to a telephone subscriber number, a transformation of the source code in the modified, structured document is carried out in order to support a communications connection in conjunction with a communications device.

### BACKGROUND OF THE INVENTION

The present invention relates to a data-processing information system for communicating with a subscriber on the basis of natural language.

Packet-oriented networks such as, for example, the WWW (World Wide Web), and local networks (LAN), for example, in the form of an “Intranet,” etc., increasingly form the main source for the exchange of information with users in a large number of application areas. For the sake of brevity, such information-transmitting networks will be referred to below by the term “WWW.”

Because a growing user group relies on information available on the WWW, the need for access to this information at any time is growing. This access usually takes place using a workstation computer which is connected via data lines to one or more WWW servers and on which a software package, known to the person skilled in the art as a “browser,” runs in order to represent the information available on the WWW servers and to navigate within the available information. This representation is predominantly made using a visual output.

A main component of such information is data available in text format, which also contains graphics, and cross-references to related information, also known to the person skilled in the art as “links,” etc. This information is usually exchanged in the form of structured documents between a WWW server and an associated communications terminal, also referred to as a Client in the specialist world; for example, in the form of a browser. This is to be understood as meaning an organization of a definable quantity of data which, in addition to the actual information which is to be represented to the user, also contains computer-readable instructions relating to its structure. For the exchange of structured documents on the WWW, the HTML format (HyperText Markup Language) is predominantly used today.

In view of the expansion of the HTML format, numerous software packets, such as, for example, Microsoft Word from the company Microsoft Corp., offer the possibility of converting formatted documents into HTML code for structured documents. Here, the HTML code which is generated by this software packet can be subsequently edited by the user. Such software packets, which do not generally require any special knowledge of code conversions into HTML, are referred to below by the term “format-based editor” for structured documents.

The necessity mentioned at the beginning of access at any time to information on the WWW increasingly also includes situations in which a person does not have a workstation computer with a visual output. For this reason, it is increasingly necessary to access the information present on the WWW in other forms of presentation; for example, in an audio format via conventional telephones.

Speech-based navigation and transmission of information on the WWW is known as an interactive speech dialogue method, also referred to by the person skilled in the art as an Interactive Voice Response (IVR). The IVR method has its roots in dialogue-oriented speech systems for lessening the burden of carrying out routine functions and for administering queues in call centers. For this purpose, the IVR method generally has an implementation of a speech-prompted menu in which a user has the choice between different options using speech or else by activating telephone keys.

A standard for implementing an IVR based WWW navigation is VoiceXML (Voice Extensible Markup Language), standardized by the “World Wide Web Consortium,” currently in the Version 1.0, issued on May, 5, 2000 (http://www.w3.org/TR/voicexml/). This standard makes it possible to design structured documents in which information is called using speech communication. This speech communication is carried out, on the one hand, by outputting text contained in a VoiceXML script as speech to a user, and on the other hand by processing an instruction which is spoken by the user.

Calling information on a speech basis using VoiceXML requires structured documents to be drawn up and made available on a WWW server in the VoiceXML format. As a result, a user is restricted to information which is defined in this format on a WWW server and, in particular, he/she cannot access HTML documents. This embodiment, therefore, corresponds to server-end support of the IVR method. In addition to the above-mentioned disadvantage of only restricted access to information, VoiceXML disadvantageously makes greater demands of the WWW server computing power for the generation and analysis of speech. In addition, transmission capacities of the data networks which transmit the information are heavily loaded because speech information which is required and/or output into the data network for control purposes is generally transmitted as digitized audio signals. This constitutes a considerable increase in the quantity of data to be transmitted in comparison to navigating in a structured document via a mouse click or keyboard input. A further disadvantage is a higher degree of expenditure for drawing up structured documents in VoiceXML format, which process usually runs in parallel with an HTML drawing-up process.

The international patent application WO99/46920 discloses a system for navigation on the WWW with a conventional telephone. The central component of this system is a host computer system having a modem and a telephone-controlled audio WWW browser (TAWB). A subscriber dials into this system by dialing a call number assigned to the modem in a telephone network. After a successful signing-on process, the modem of the host computer system acts as an interface between the TAWB and the telephone network. The subscriber can transfer commands to the TAWB for navigation or control purposes in a spoken form or else in the form of DTMF (Dual Tone MultiFrequency) signals by activating telephone keys. The TAWB interprets the commands, loads the corresponding WWW documents and converts the information contained in them into an audio format. The information is then transmitted via the telephone network to the telephone at which the subscriber can hear it. Conversion of textual data into audio information is carried out by a process known to the person skilled in the art as TTS (Text to Speech).

The US patent document U.S. Pat. No. 6,018,710 discloses a method for converting structured documents into audio signals via the TTS method, particularly taking into account structural instructions contained in them.

Both methods or arrangements disclosed in the above publications operate, in contrast to the server-end implementation by VoiceXML, with a client-end implementation of the IVR method. Therefore, a user can search for information in any structured documents without taking up large amounts of transmission capacity as mentioned above with respect to VoiceXML. However, a client-end conversion of a structured document, which may possibly have a complex structure, into speech information has the disadvantage of confusing a user who is navigating in this document by voice as a result of the loss of the visual structuring of the document in the course of the conversion.

An object of the present invention, therefore, is to specify a method which ensures that structured documents are developed on the basis of format-based editors for structured documents without the need for expert knowledge for these structured documents to be called simultaneously by a visual browser and by an IVR-based browser.

### SUMMARY OF THE INVENTION

According to the present invention, a structured document is received and transformed into a modified structured document, the number, format and/or arrangement of cross-references for a transformation into a structured menu structure, suitable for operation with IVR-based browsers, is carried out within the framework of an analysis of the source code of the structured document. It also includes the handling of a cross-reference to a telephone subscriber number, which cross-reference is converted in order to carry out a communications link in conjunction with a communications device in the modified structured document.

A significant advantage of the method according to the present invention is the fact that, after the development of a document which is structured for visual browsers, it is also possible to access this document with a browser which operates according to the IVR method. This thus obviates the need for costly dual development and maintenance of structured documents in two different protocols.

The analysis and modification of the structured document stored on the WWW server is particularly advantageous with respect to the running time, which does not require any additional preparation of storage capacity on the WWW server.

It is also advantageous that the development of structured documents requires little knowledge of the source code which is generated automatically by the format-based editor, for example in an HTML format.

Additional features and advantages of the present invention are described in, and will be apparent from, the following Detailed Description of the Invention and the Figures.

### BRIEF DESCRIPTION OF THE FIGURES

FIG. 1 is a structured diagram schematically representing communication terminals which are connected to a packet-oriented network.

FIG. 2 is a schematic view of a document as the basis of a structured document.

### DETAILED DESCRIPTION OF THE INVENTION

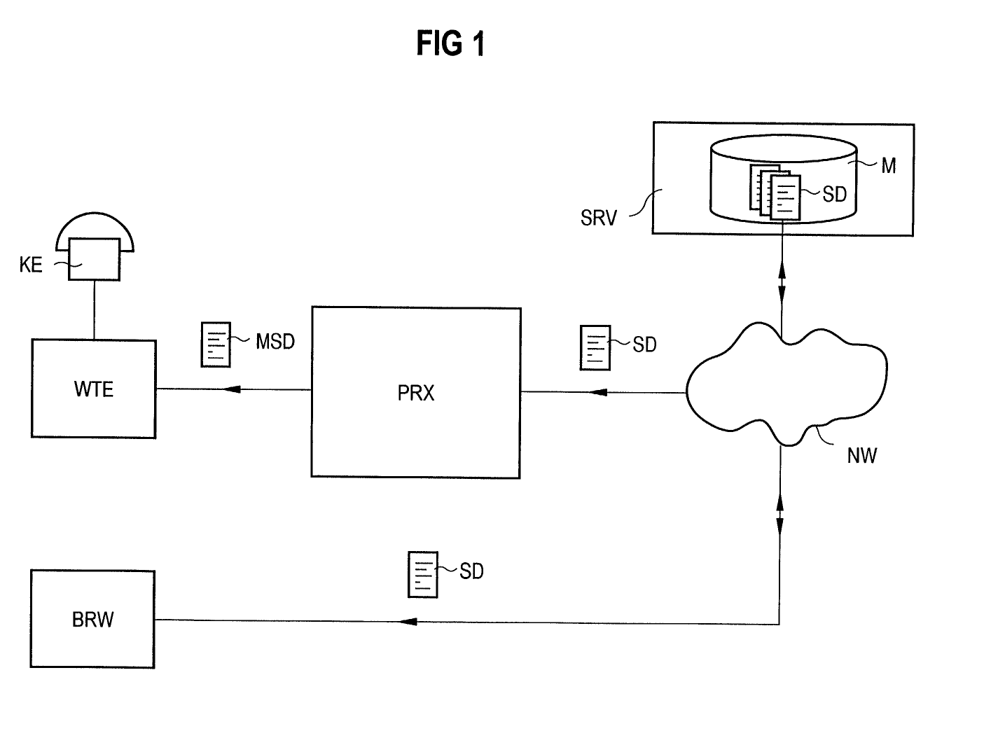

FIG. 1 illustrates a communications terminal KE which is connected bidirectionally to a packet-oriented network NW, for example the Internet or a local network, via a browser WTE which operates according to the IVR method (Internet Voice Response), referred to below as “IVR browser” WTE for the sake of simplification, and a proxy server PRX. Furthermore, a conventional browser BRW, that is to say one which outputs information on a visual output (not illustrated) is bidirectionally connected to the packet-oriented network NW.

The connection of the IVR browser WTE and of the conventional browser BRW to the packet-oriented network NW is understood, in particular, to refer to its software operating on a computer system (not illustrated) which has appropriate software and hardware components for making available a bidirectional exchange of data with what is referred to as an Internet Service Provider (not illustrated).

The IVR browser WTE corresponds in its method of operation to, for example the “Web Telephony Engine” from Microsoft Corp., which is described in the Internet document pool “Microsoft Developers' Network,” specifically at the address http://msdn.microsoft.com/library/default.asp?url=/library/en-us/htmltel/wtestartpage 61et.asp (without date information, contents referred to Nov. 8, 2001) and in the patent application with the internal file number 2001P21321. Both commands spoken by the user, which are converted into control instructions in the IVR browser WTE via a method which is known to the person skilled in the art as a speech recognition or SR method, and DTMF (“Dual Tone Multifrequency”) signals which are transmitted to the IVR browser WTE and which are triggered by the user by activating their respective key on the communications terminal KE, are used to control the IVR browser WTE by a user operating the communications terminal KE.

The “connection” of, for example, the IVR browser WTE to the packet-oriented network NW, which is, in fact, without connections by its very nature, is to be understood as a source location or destination location of data packets between two communications terminals which are connected to the packet-oriented network NW. For the sake of easier illustration, the term “connection” will continue to be used. Likewise, for reasons of ease of illustration, data packets which are exchanged with the packet-oriented network NW are illustrated in the drawing using continuous lines.

On a WWW (World Wide Web) server SRV which is also connected to the packet-oriented network NW, structured documents SD are administered for requesting by a client, for example, by one of the two browsers WTE, BRW, in a memory M. With an arrow pointing from right to left, two structured documents SD are graphically illustrated during a loading process by the corresponding Client; that is to say, the IVR browser or the conventional browser BRW. The method according to the present invention which is to be described gives rise to the transformation of the structured document SD into a modified, structured document MSD which is intended for the IVR browser WTE. Both the exchange of structured documents SD and the exchange of modified, structured documents MSD is generally accompanied by an exchange of further files (not illustrated), also referred to as library files, which contain, for example, object definitions and/or style definitions or configuration data.

The design of the proxy server PRX corresponds to the information host computer PRX described in the patent application with the internal identification number 2001P21321. This proxy server PRX is equipped with devices such as, for example, central processors, main memories, etc., which are customary in computer systems and which ensure that the method according to the present invention is executed. The proxy server PRX is a possible variant for carrying out the method according to the present invention in a computing unit. Alternatively, the method can also run in the IVR browser, in the WWW server SRV or in a server which has a hierarchically different structure.

The structured documents SD which are stored in the memory M of the WWW server are generated using a format-based editor. The Microsoft Word software from Microsoft Corp. is used, for example, as the format-based editor and permits a structured document SD to be developed in the form of an HTML page. After the structured document SD is completed, it is stored in the HTML format, transferred to the WWW server SRV and stored in its memory M.

Microsoft Word makes available tools for generating an HTML page which permit this HTML page to be configured by a user without detailed knowledge of an associated HTML source code. After calling a template for HTML pages, a user can edit a desired text in a way which is customary for text processing systems and provide this text with corresponding formatting in a way suitable for the presentation of the later HTML page. In addition to formatted text, it is possible to insert graphics, and cross-references to related information (also known to the person skilled in the art as “links”), etc. In Microsoft Word, formatting and cross-references are converted into corresponding computer-readable instructions in the generated HTML source code during the storage of the edited text. This conversion is carried out via a defined procedure which ensures a reproducible structure of the generated source code.

The simplicity of an HTML draft which is achieved using Microsoft Word or some other format-based editor FE is associated, according to the present invention, with an advanced conversion technology which permits access to information of the structured document SD with the IVR browser WTE.

In the structured document SD, the HTML page, generated by Microsoft Word, these instructions are used for a structured representation of the information contained on a browser. The instructions are usually composed of HTML instructions which are composed of marking points, or what are referred to as “tags,” and associated parameters. A listing and explanation of these tags is given, for example, in the Internet document Part 1, Hubert: “HTML-Einführung” [Introduction to HTML] (http://velociraptor.mni.fh-giessen.de/html/hein.html#index) in Version 97.9 of September 1997. For this reason, a syntactic and semantic explanation of tags will not be given in this description.

The definition of cross-references, for example to other structured documents, other regions of the structured document or else to a file which is to be loaded and output and/or executed, is carried out in Microsoft Word with a processing tool which assigns a region to be marked to a destination address; also referred to in the specialist world as URL (Uniform Resource Locator). Alternatively, a cross-reference can be used to refer to another file; for example, present in the memory M of the WWW server.

The URL contains an entry relating to a directory location and a file name of the file in which the desired information is stored. Further components of the URL are an entry relating to the method of data access, an indication of a WWW server which administers the file and possibly the location within the file or parameter for a search process or for a script program which runs on the WWW server and which is also referred to in the specialist world as a CGI (Common Gateway Interface) program.

The configuration of a structured document SD will be explained in more detail below with further reference to the functional units in FIG. 1.

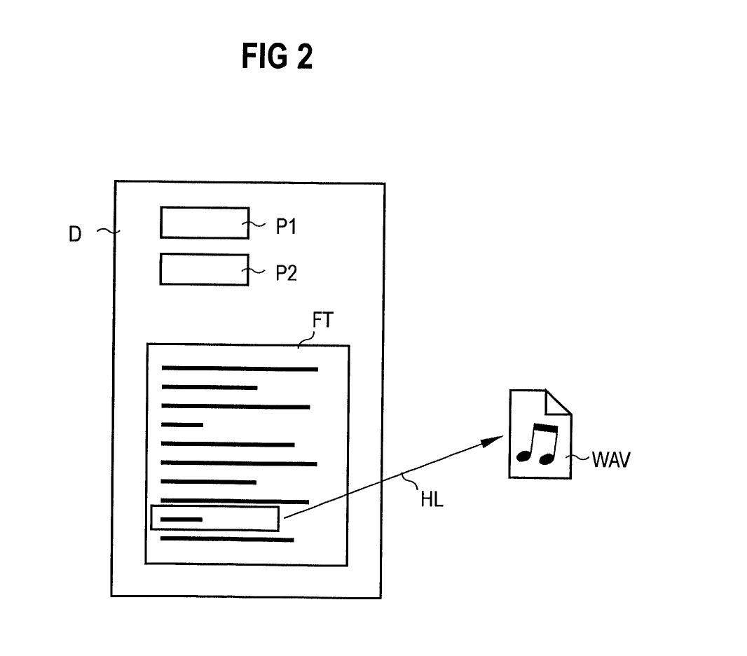

FIG. 2 is a schematic view of information elements and configuration conventions of a document D which is processed in Microsoft Word. This document D is the basis for the generation of the associated structured document SD in the HTML format which is carried out via Microsoft Word in a subsequent step. In a later step, this structured document SD is stored in the memory M of the WWW server and is, thus, available both to the conventional browser BRW and to the IVR browser WTE for calling. The calling of the structured document SD by the UVR browser is carried out with an “intermediate connection” of the proxy server PRX which transforms the structured document SD into the modified, structured document MSD in accordance with a method to be explained below.

The document D is composed, inter alia, of a format text FT and of a number of property boxes P1, P2, of which only two are illustrated for reasons of clarity. The format text FT includes the content which is to be illustrated by the structured document SD and which contains both textual information and graphics, cross-references, etc.

The property boxes P1, P2 serve to hold information for handling the structured document SD which is generated later and/or the modified, structured document MSD which is generated using the method according to the present invention, which information is to be entered in the development phase of the document D. The information which is entered in the property boxes P1, P2 is thus also available in the same way in the structured document SD which is generated from the document D and, if applicable, also in the modified, structured document MSD. It is concealed, however, from a receiver (i.e., a user operating the conventional browser BRW or the IVR browser WTE) of the structured document SD or of the modified, structured document MSD. Boxes which are provided, for example, for entering data properties of the document D can be used as property boxes P1, P2.

Depending on the information entered in the first property box P1, the proxy server PRX determines whether a transformation into a modified, structured document MSD is to be performed, or whether the structured document SD is to be passed on without modification to the Client which is calling the structured document SD. In the first property box P1, the developer of the document D thus makes an entry which characterizes an application in the IVR browser WTE which processes the later modified document MSD. This information in the property box P1 is used by the proxy server PRX for assessing whether the structured document SD generated from the document D is to be converted into a modified, structured document MSD before being passed on to the calling Client. If there is no information in the property box P1, or information which is not to be assigned to an application, the structured document is passed on without modification to the calling Client.

In the second property box P2, the developer of the document D is to make an entry which contains information relating to an assignment of DTMF signals which is to be used. An assignment of DTMF signals by the IVR browser WTE to numbers, letters or special characters is made here as a function of an information item which is entered in the second property box P2 or else as a function of a configuration file whose file name and/or address is entered in the second property box P2. The configuration file can be stored here in the memory M of the WWW server SRV or in a memory (not illustrated) in the IVR browser WTE. Alternatively, entries of the configuration file can be made in a database (not illustrated) in the WWW server SRV or in the proxy server PRX.

The explained entries into the property boxes P1, P2 of the document D represent preconditions for the user of the IVR browser WTE to be able to call the structured document SD generated therefrom, using the method according to the present invention which is to be described. The method according to the present invention carries out the transformation of the structured document SD into the modified, structured document MSD. During this transformation, instructions in the HTML source code and/or attributes of these instructions are modified; i.e., expanded, added and/or replaced. The transformation also includes the addition of further computer-readable instructions, what are referred to as scripts (for example, Java scripts or Visual Basic scripts) in the form of independent files or as a component of the modified, structured document MSD.

In addition to the inputting of the explained information into the property boxes P1, P2, the developer of the document D has to comply with a configuration convention for the format text FT, which convention will be described below.

A characteristic of the method according to the present invention is a vocal reproduction of the content of the modified, structured document MSD by the IVR browser, which is not based exclusively on a TTS (Text to Speech) conversion. Instead, measures are taken, as early as the development of the document D, to ensure a more natural reproduction of the format text FT via a large degree of assignment HL of audio files WAV to text elements in the format text FT. This assignment of a text passage to an audio file WAV which reproduces the contents of this text passage in the natural language takes place when the document D is edited by defining a cross-reference (or also “link” or “hyperlink”) to the file. This file either can be localized as what is referred to as a “local file” on the WWW server SRV on which the structured document SD is also located, or also at another server (not illustrated) on the WWW or Intranet. The processor of the document has to enter this cross-reference with a URL in the form of what is referred to as a “Get-String” type in the form of a question mark (“?”) and indicate the processing application (IWRVoice-File, see below). In the case of a reference to the file “welcome.wav” of the WWW address www.siemens.com, the user is to enter the following cross-reference: http://www.siemens.com/?IWRVoiceFile=welcome.wav.

According to these conditions for the configuration of the document D, the inventive transformation of the structured document SD into the modified, structured document MSD will be explained below with reference to examples of HTML code. A functional hardware environment of the method can be found in the patent application with the internal file number 2001P21321. A syntactic analysis of the HTML source code is performed here in the structured document SD for the transformation. A structured access to the HTML source code is possible here using HTMLDOM objects (HTML Document Object Model). These HTMLDOM objects are transferred, by a transformation device (not illustrated), into the modified, structured document MSD with a source code in the format XML (Extended Markup Language). The analysis of the HTML source code and the transformation into the XML source code takes place at the running time; i.e., when the IVR browser WTE accesses the structured document SD on the WWW server SRV.

The method according to the present invention will be explained below with respect to the processing of cross-references or links. Different requirements are placed on the presentation of the information contained in the speech-based IVR browser WTE depending on the presentation of these links in a text context.

Cross-references are illustrated in an HTML document on a visually structuring browser BRW in the following way, for example:

### Additional Information:

### Link Wave Table Form

Here, the underlining of a region, that is to say of a word (“Link,” “Wave,” “Table” or “Form”) or of a text passage, serves as an indication to the operator that activating this region with an input device (for example, a mouse) causes further information to be displayed. This further information is displayed by calling a further, structured document SD, another region in the current, structured document SD or else by calling a file. In the case shown above, the links are arranged separately from an explanatory text (“Additional Information:”).

To select a link, the user of the speech-based IVR browser WTE is provided with the possibilities of either activating a key or vocally specifying the respective cross-reference (“Link,” “Wave,” “Table” or “Form”). The text passage “Additional Information:” has the function of describing the cross-references “Link,” “Wave,” “Table” and “Form” under it.

Instead of an exclusive TTS conversion of the content of a structured document SD provided for visual structuring, one object of the method here is to perform graphic structuring into a user-friendly mode of operation on the basis of the structured, spoken language. For example, an introductory announcement relating to the selectable links is advantageous for the purpose of an introductory display of optional cross-references which can be selected by the user of the speech-based IVR browser WTE.

The integration of audio data WAV permits an introductory announcement for the operator of the IVR browser WTE in a natural description of selectable cross-references. For example, the content of an audio file WAV “info.wav” can contain a spoken form of the text passage “Additional Information:” which is expanded with information relating to the selectable cross-references and their selection method, for example in the form:

“For additional information use the following links. For link press 1, for wave press 2, for table press 3, for form press 4”

Here, a selection of cross-references is accepted by activating a respective key. The developer of the document D must be careful here to match the arrangement of the cross-references to the contents of the audio file WAV. At a later point in this description, a mode of operation via speech recognition in accordance with the SR (Speech Recognition) method which is known per se will be explained using an instruction generated from the speech input of the user.

With a definition of the text passage “Additional Information:,” carried out by the developer of the document D, as a cross-reference to the audio file WAV “info.wav” in a subdirectory “waves,” Microsoft Word generates the following HTML source code section:

<a href=“waves/info.wav”>Additional Information:</a>

This HTML source code section is changed as follows into an XML source code section when there is a transformation into the modified, structured document MSD:

<p VoiceFile=“waves/info.wav”>Additional Information:</p>

The marked point—tag—“<a>” (“anchor”) is changed here into “<p>” (“paragraph”), and the link instruction “href” (“hypertext reference”) is replaced by the instruction “VoiceFile=,” which is computer-readable by the IVR browser, for the reproduction of the audio data WAV “info.wav” (cf. the above-mentioned document for the meaning of the tag). If no cross-reference to an audio file WAV is defined for the text passage “Additional Information:” by the developer of the document D, this passage is converted into speech by the TTS method in the IVR browser.

The above-mentioned cross-references defined in the document D give rise to the following HTML source code generated by Microsoft Word:

<p class=MsoNormal>
<a href=“waves/info.wav”>Additional Information:</a>
</p>
<p class=MsoNormal>
<a href=“#Link_Test”>Link</a>
<a href=“#Wave_Test”>Wave</a>
<a href=“#Table_Test”>Table</a>
<a href=“#Form_Test”>Form</a>
</p>

The cross-references (“Link,” “Wave,” “Table” or “Form”) refer to regions of the currently structured document SD which are defined with the respective suffix “_Test” and which the user has defined with the processing tool in order to define cross-references. A cross-reference to a region is indicated by the hash symbol (“#”). Further key words such as “MsoNormal” are additional information which is inserted by Microsoft Word and is irrelevant to the decoding of the HTML mode and is removed during the transformation of the structured document SD into the modified, structured document MSD.

The XML source code which results after transformation of the structured document SD into the modified, structured document MSD is represented as follows.

<p VoiceFile=“waves/info.wav”>Additional Information:</p>
<p>
<a VoiceFile=“waves/silence.wav”href=“#Link_Test”>Link</a>
<a VoiceFile=“waves/silence.wav”href=“#Wave_Test”>Wave</a>
<a VoiceFile=“waves/silence.wav”href=“#Table_Test”>Table</a>
<a VoiceFile=“waves/silence.wav”href=”#Form_Test”>Form</a>
</p>

Here, an instruction for the execution of an audio file WAV “silence.wav” (“silence”) is inserted into each individual cross-reference entry by the transformation and has the function of suppressing the TTS conversion and announcement of this cross-reference. This announcement can be dispensed with as a result of the introductory announcement of the audio file WAV “info.wav.” The cross-reference to the audio file WAV “silence.wav” is made, as before, by the introduction of the attribute “VoiceFile=”, which has the function of an instruction for the IVR browser WTE to play this file WAV. As a result of the transformation, the marked point, or tag, of a cross-reference is changed from <a> into <p>.

If there is no introductory text passage (for example, “Additional Information:” as above) for a group of linking cross-references, the designation of the cross-reference (“Link,” “Wave,” “Table” or “Form”) is placed in a context which explains selection and activation possibilities of these cross-references to the user of the IVR browser. From the HTML source code generated by Microsoft Word, without the passage “Additional information:” (cf. above)

<p class=MsoNormal>
<a href=“#Link_Test”>Link</a>
<a href=“#Wave_Test”>Wave</a>
<a href=“#Table_Test”>Table</a>
<a href=“#Form_Test”>Form</a>
</p>

the following XML source code:

<STYLE>

A.Menu1
{

cue-before: For;
cue-after: Press %1;

}

</STYLE>
<p>
<a class=“Menu1”href=“#Link_Test”>link</a>
<a class=“Menu1”href=“#Wave_Test”>wave</a>
<a class=“Menu1”href=“#Table_Test”>table</a>
<a class=“Menu1”href=“#Form_Test”>form</a>
</p>

is generated after transformation of the structured document SD into the modified, structured document MSD.

As a result of the transformation, a style element (“STYLE”) is inserted which surrounds the cross-reference designations (“Link,” “Wave,” etc.) with an explanation in a TTS method to be applied to it. The user of the IVR browser listens to the explanation “For Link Press 1, for Wave press 2, for Table press 3, for Form press 4.” The parameter “%1” of the class “Menu1,” method “cue-after” brings about an incremented number depending on the number of cross-references. The class attributes class=“Menu1” are entered in each cross-reference entry. In this case also, it is the responsibility of the developer of the document D to make the numbers assigned in the sequence of the references consistent with the content of the audio file WAV.

The transformation of associated cross-references which is described above is carried out in a largely analogous way with different structural forms. Structuring with structural signs will be explained as a further example:

Link

Wave

Table

Form

The above-mentioned cross-references defined in the document D give rise to the following HTML source code generated by Microsoft Word:

<ul style=‘margin-top:0in’type=square>
<li class=MsoNormal style=‘mso-list:10 level1 lfo3;
tab-stops:list .5in'>
<a href=“#Link_Test”>Link</a>
</li>
<li class=MsoNormal style=‘mso-list:10 level1 lfo3;
tab-stops:list .5in’>
<a href=“#Wave_Test”>Wave</a>
</li>
<li class=MsoNormal style=‘mso-list:10 level1 lfo3;
tab-stops:list .5in’>
<a href=“#Table_Test”>Table</a>
</li>
<li class=MsoNormal style=‘mso-list: 10 level1 lfo3;
tab-stops:list .5in’>
<a href=“#Form_Test”>Form</a>
</li>
</ul>

The XML source code which results after transformation of the structured document SD into the modified, structured document MSD, is represented as follows:

<STYLE>

A.menu2
{

cue-before: For;
cue-after: Press %1;

}

</STYLE>
<ul>
<li><a class=“Menu2”

href=“#Link_Test”>Link</a></li>

<li><a class=“Menu2”

href=“#Wave_Test”>Wave</a></li>
<li><a class=“Menu2”
href=“#_Table_Test”>Table</a></li>

<li><a class=“Menu2”

href=“#Form_Test”>Form</a></li>

</ul>

As an alternative to operating the IVR browser via keys to select an option, operation with a spoken word is also possible, the word being converted into a corresponding command via a TTS method implemented in an IVR browser. The XML source code of the modified, structured document MSD is illustrated below if a transformation of the structured document into a modified, structured document MSD in order to support the SR (Speech Recognition) method has been set in the document D; for example, via a property box (not illustrated) which corresponds to the first two property boxes P1, P2.

<STYLE>

A.IWRMenuContinue
{
Cut-Through: YES;
cue-before: To;
cue-after: Press %1 or Say continue;
}

</STYLE>
<body lang=EN-US>
<ul>
<li><a Style=“Cut-Through: YES;cue-before: To select;

cue-after: Press %1 or Say link;”
href=“#_Link_Following_Test”>Link</a></li>

<li><a Style=“Cut-Through: YES;cue-before: To select;

cue-after: Press %1 or Say wave;”
href=“#_Wave_File_Test”>Wave</a></li>

<li><a Style=“Cut-Through: YES;cue-before: To select;

cue-after: Press %1 or Say table;”
href=“#_Table_Test”>Table</a></li>

<li><a Style=“Cut-Through: YES;cue-before: select;

cue-after: Press %1 or Say form;”
href=“#_Form_Input_Test”>Form</a></li>

<a Class=IWRMenuContinue href=”#menu1_continue”>continue
</a>
</ul>
<a name=“menu1_continue”></a>

An instruction “Press 2 or say Wave,” for example, informs the operator of the IVR browser WTE of the possibility of activating the cross-reference “Wave” by uttering this word. As in the previous case, during the transformation a group of references is determined and converted into a menu structure using the <ul>/<li> tags. Because the developer of the document D does not foresee any use of an audio file WAV for audibly explaining the selectable options, the style element (“STYLE”), which surrounds the cross-reference designations (“Link,” “Wave,” etc.) with an explanation in a TTS method which is to be applied to it, is inserted. In order to permit the operator to use the method “Cut-Through” to jump over the remaining announcement chain when selecting an element, a “Continue” option is also inserted at the end of the menu. The setting of this “Continue” option can be determined, for example, by a property box (not illustrated) in a way analogous to the two property boxes P1, P2.

As an alternative to the structure shown above, links can also occur in a text grouping, as illustrated on the following line:

Follow this external link to the CNN News website.

Follow this link to the last section of this page.

As shown above for the case of a cross-reference to an audio file WAV, a processor of the document D in Microsoft Word defines the target file or target address of a link by marking the text (for example “CNN News”) and activating a processing tool in Microsoft Word with which an entry can be made in the target file or target address (for example “http://www.cnn.com”) which is to be linked to the region.

The abovementioned cross-references defined in document D give rise to the following HTML source code generated by Microsoft Word:

<p class=MsoNormal>Follow this external link to the

<a href=“http://www.cnn.com/”>CNN News</a>website.</p>

<p class=MsoNormal>Follow this link to the

<a href=“#last_section”>last section</a>of this page.</p>

The XML source code which results after transformation of the structured document SD into the modified, structured document MSD is illustrated below:

<STYLE>

A.menu4
{

cue-before: url(waves/Bing.wav)

}

</STYLE>
<STYLE>

A.menu5
{

cue-before: url(waves/Bing.wav)

</STYLE>
<script language=“VBScript” for=“single_link1” event=

“onselectiontimeOut”>
window.navigate(“#single_link1_continue”)

</script>
<script language=“VBScript” for=“single_link2” event=

“onselectiontimeOut”>
window.navigate(“#single_link2_continue”)

</script>
<p>Follow this external link to the </p>
<p id=“single_link1”>

<a class=“Menu4”href=“http://www.cnn.com”>CNN News</a>
<a href=“#single_link1_continue”></a>

</p>
<p><a id=“single_link1_continue”></a>web site.</p>
<p>Follow this link to the </p>
<p id=“single_link2”>

<a class=“Menu4”href=““#last_section”>last section</a>
<a href=”#single_link2_continue”></a>

</p>
<p><a id=“single_link2_continue”></a> of this page.</p>

The transformed XML source code causes a signal tone, audio file WAV bing.wav,” to be played before the announcement of the cross-reference which signals a following cross-reference to the operator of the IVR browser. The TTS conversion of the text is continued with a parameterizable time period after which an event is triggered (“onselectiontimeout”).

Another variant of the transformed XML source code provides the possibility of allowing the operator himself/herself to make the selection as to whether he/she would like to continue to a cross-reference after a message or whether, for example, he/she still requires time to think about the information. Which of these two variants is generated by a transformation can be entered, for example, in a property box (not illustrated) in a way analogous to the two property boxes P1, P2.

<STYLE>

A.menu4
{

cue-before: For;
cue-after: press %1;

}

</STYLE>
<STYLE>

A.menu4Continue
{

cue-before: To continue;
cue-after: press %1;

}

</STYLE>
<STYLE>

A.menu5
{

cue-before: For;
cue-after: press %1;

}

</STYLE>
<STYLE>

A.menu5Continue
{

cue-before: To continue
cue-after: press %1

}

</STYLE>
<script language=“VBScript” for=“single_link1”

event=“onselectiontimeOut”>
window.navigate(“#single_link1_continue”)

</script>
<script language=“VBScript” for=“single_link2”

event=“onselectiontimeOut”>
window.navigate(“#single_link2_continue”)

</script>
<P>Follow this external link to the </p>
<p id=“single_link1”>
<a class=“Menu4”href=“http://www.cnn.com”>CNN News</a>
<a class=“Menu4Continue”href=“#single_link1_continue”></a>
</p>
<p><a id=“single_link1_continue”></a>web site.
</p>
<P>Follow this link to the </p><p id=“single_link2”>
<a class=“Menu5”href=“#last_section”>last section</a>
<a class=“Menu5Continue”href=“#single_link2_continue”></a>
</p>
<p><a id=“single_link2_continue”></a> of this page.</p>

The transformation of highlighted points in texts will be explained below. When there is a TTS conversion, points in the text which are highlighted, for example via italics, bold or underlining, are to be correspondingly marked for the operator of the IVR browser WTE. This marking is carried out using a scheme based on the marking points (tags) of the structured document SD. The scheme converts underlined points in texts, framed with the tag <u> in the HTML source code, into instructions which bring about an increase in the volume of the correspondingly marked passages for the TTS method. The same applies to passages of text in italics, which are framed with the tag <i> in the HTML source code and are converted into a quicker announcement (“speech rate”) of the text, and for bold passages of text which are converted into an announcement with a deeper pitch. A format text FT which is to be displayed on a visual browser and which has different instances of highlighting will be used below for explanation purposes.

When this page is accessed via the telephone, the method will analyze the HTML and check whether the WAV file can be downloaded. If it can, then the method will play the WAV file, otherwise it will insert the link anchor text (which, as suggested above, should be textual equivalent of the WA Vfile content) which will be rendered by the text-to-speech engine.

The abovementioned format text FT which is defined in the document D gives rise to the following HTML source codes generated by Microsoft Word:

<p class=MsoNormal><span lang=EN style=‘mso-ansi-language:EN’>When this page is accessed via the telephone, <u>the method</u> will analyze the HTML and check whether the WAV file can be downloaded. If it can, then <b>the method</b> will play the WAV file, otherwise it will insert the link anchor text (<i>which, as suggested above, should be textual equivalent of the WAV file content</i>) which will be rendered by the text-to-speech engine.</p>

The XML source code which results after transformation of the structured document SD into the modified, structured document MSD is represented below.

<STYLE>

| | |
|---|---|
| u | { |
| | pitch:190; |
| | volume:high; |
| | speech-rate:180; |
| | } |
| i | { |
| | pitch:190; |
| | volume:medium; |
| | speech-rate:220; |
| | } |
| b | { |
| | pitch:150; |
| | volume:medium; |
| | speech-rate:180; |
| | } |

</STYLE>

<p>When this page is accessed via the telephone, <u>the method</u> will analyze the HTML and check whether the WAV file can be downloaded. If it can, then <b>the method</b> will play the WAV file, otherwise it will insert the link anchor text (<i>which, as suggested above, should be textual equivalent of the WAV file content</i>) which will be rendered by the text-to-speech engine.</p>

In the definition of forms in document D, which forms include various input elements such as text input boxes, option boxes (“radio buttons”), check boxes, list boxes or combination boxes (“pull-down menus”), a transformation of the HTML source code to enrich application-oriented user operation for the operator of the IVR browser WTE is also necessary.

Text input boxes have a description (“label”) which provides a user with an explanation of the information to be input. The HTML source code, generated by Microsoft Word, of a text input box which is drawn up in the document D and provided with the explanation “Last Name:” is represented below:

<p class=MsoNormal>Last Name: <INPUT TYPE=“TEXT”

NAME=“personal_lastname”></p>

The XML source code which results after transformation of the structured document SD into the modified, structured document MSD is represented below.

<STYLE>
label.textlastname

{

Cut-Through: YES;
cue-before: “Pease enter the information for”;

}

</STYLE>
<p>
<label class=“textlastname” for=“tlastname”> Last Name:
</label>
<INPUT TYPE=“TEXT” NAME=“personal_lastname”
id=“textlastname”/></p>
</p>

In addition, under certain circumstances a script instruction (not illustrated for reasons of space), which handles an SR (Speech Recognition) conversion or a DTMF conversion of a text content which is desired by the operator of the IVR browser and is to be input, is necessary in the XML instruction set. The inputting of letters using a keyboard is carried out, for example by repeatedly activating the keys, each key being assigned a number of letters, generally three or four, in accordance with an assignment scheme known to the person skilled in the art. The repeated activation also can be dispensed with by using a word lexicon and in an analogous application of the “T9” method known from mobile phone technology.

Optional boxes have, like text input boxes, a description (“Name”) which provides a user with an explanation of the option to be selected. Only one option can be selected in one group of option boxes. The HTML source codes generated by Microsoft Word of two option boxes which are drawn up in the document D and provided with the description “Male” or “Female” are represented below:

<p class=MsoNormal>
<span lang=EN style=‘mso-ansi-language:EN’>Male</span>
<INPUT TYPE=“RADIO” NAME=“gender” VALUE=“Male”>
<span lang=EN style=‘mso-ansi-language:EN’>
<span style=“mso-spacerun:yes”> </span>
Female </span><INPUT TYPE=“RADIO” NAME=“gender”
VALUE=“Female”>
<span lang=EN style=‘mso-ansi-language:EN’><o:p></o.p></span>
</p>

The XML's source code results after transformation of the structured document SD into the modified, structured document MSD is represented as follows:

<STYLE>
label.radiogender

{

Cut-Through: YES;
cue-before: “to select”;
cue-after: “PRESS %1”;

}

</STYLE>
<P>
<label class=“radiogender” for “rmale”> Male </label>
<INPUT name=“gender”id=“rmale” type=“radio” value=“Male”/>
<label class=“radiogender” for “rfemale”> Female </label>
<INPUT name=“gender” id=“rfemale” type=“radio”
value=“Female”/>
</P>

Check boxes have a description (“Name”) of a subject matter, and a selection description (“Label”) of the selectable check box. In contrast to option boxes, a number of check boxes can be selected in one group of check boxes. The HTML source code which is generated by Microsoft Word for two check boxes provided with the selection description “Java” or “Basic” with the common description “Software Skills” is represented below:

<p class=MsoNormal><span lang=EN style=‘mso-ansi-
language:EN’>Java </span><INPUT TYPE=“CHECKBOX”
NAME=“software_skills” VALUE=“java”><span
lang=EN style=‘mso-ansi-language:EN’><span style=“mso-
spacerun:
yes”> </span>Basic <INPUT TYPE=“CHECKBOX”
NAME=“software_skills”
VALUE=“basic”><o:p></o:p></span>
</p>

The XML source code which results after transformation of the structured document SD into the modified, structured document MSD is represented below:

<STYLE>
label.sclabel

{

Cut-Through: YES;
cue-before: “Press %1 to select”;

cue-after: “Press %2 to continue”;
}

</STYLE>
<p>
<label class=“sclabel” for=“scheckboxjava”> Java</label>
<INPUT id=“scheckboxjava” name=“software_skills”
type=“checkbox” value=“java”/> <label class=“sclabel”
for=“scheckboxbasic”> basic</label>
<INPUT id=“scheckboxbasic” name=“software_skills”
type=“checkbox” value=“basic”/>
</p>

The TTS-converted selected description of each check box is used here for the operator announcement at the IVR browser WTE. Each check box is processed here individually with an activation (selection) or deactivation. The operator hears the following announcement: “Press 1 to select Java, press 2 to continue,” followed by a waiting time for the user input. After the user input, the announcement “Press 2 to select Basic, press 2 to continue” is made.

In the definition of a list box, containing the entries “British,” “American,” “German,” for selection of the nationality in the document D, Microsoft Word generates the following HTML source code:

p class=MsoNormal><b><span lang=EN style=‘mso-ansi-
language:EN’>Nationality:<o:p></o:p></span></b></p>
<p class=MsoNormal><SELECT NAME=“nationality” SIZE=“3”>
<OPTION SELECTED VALUE=“British”>British
<OPTION VALUE=“American”>American
<OPTION VALUE=“German”>German
</SELECT><span
lang=EN-US style=‘mso-ansi-
language:EN-US’><o:p></o:p></span></p>

List boxes permit an option to be selected within a list of selectable options. A multiple selection of options is also possible here. The XML source code which results after transformation of the structured document SD into the modified structured document MSD is represented below:

<STYLE>
option.nlb

{

Cut-Through: YES;
cue-before: “To select”;
cue-after: “Press %1”;

}

</STYLE>
<p><b>Nationality</p></b>
<p>SELECT NAME=“nationality” SIZE=“3”>
<OPTION class=“nlb”SELECTED VALUE=“British”>British</Option>
<OPTION class=“nlb”VALUE=“American”>American</Option>
<OPTION class=“nlb”VALUE=“German”>German</Option>
</SELECT>
</p>

For all the input boxes described, the transformation into the modified, structured document MSD has been described using an input with keys. A transformation into a modified, structured document MSD also can be carried out for inputs into a form using input elements, analogous to the previously mentioned example with references which are divided up into list symbols, by setting the property box which controls the type of commands to be input by the operator in document D to a corresponding value. The transformation into the XML source code of the modified, structured document MSD takes place in an analogous structure to that of the aforementioned example.

At the end of a form for inputting data, there is usually a button for final confirmation of the inputs by the operator. This confirmation button (“Submit Button”) is handled in the modified, structured document MSD as follows: if there is only the confirmation button with the text “Submit Form,” or a similar text defined in another language, the data which is input is transferred without further inputs or messages. However, if a button (“Reset Form”) for resetting all the inputs is provided for the operator, a menu which generates the “Submit” selection and “Other Options” (“Others”) is generated in the modified, structured document MSD. Inputting the instruction “Other Options” (“Others”) gives rise to a presentation of (“Reset”) and “Skip” submenus.

The HTML source code generated by Microsoft Word when a “Submit Form” button exists is given below:

<p class=MsoNormal><span lang=EN style=‘mso-ansi-
language:EN’><INPUT TYPE=“Submit” ACTION=“login.asp”
VALUE=“Submit Form” METHOD=“Post”><o:p></o:p></span></p>

After transformation of the structured document SD into the modified, structured document MSD, the following XML source code, which calls a structured document “login.asp” which automatically transfers the input data is produced.

<input TYPE=“Submit” ACTION=“login.asp” METHOD=“Post” Value=“Submit”/>

If the button “Reset Form” for resetting all the inputs has been provided in the document D in addition to the “Submit Form” button, the following XML source code is generated in the modified, structured document MSD:

<STYLE>
a.otheroptions

{

Cut-Through: YES;
cue-before: “To select”;
cue-after: “PRESS %1”;

}

</STYLE>
<p>
<A class=“otheroptions” href=“#begin_form”>Reset</A>
<A class=“otheroptions” href=“#skip_form”>Skip</A>
</P>
</form>
<a id=“skip_form”></a>

The operator of the IVR browser WTE hears the following announcement generated with the TTS method: “To select submit press 1, to select others press 2.” If the operator activates the key 2 of the communications terminal KE, the following announcement is generated: “To select reset press 1, to select skip press 2.”

During the description of all the input elements, it was assumed that the document D was configured without the provision of an introductory text with linking to an explanatory audio file WAV. If the developer of the document provides, in a way analogous to the description in conjunction with the “Additional Information:” linking to an audio file WAV, such linking to information relating to the available options, in accordance with the scheme “For *** press 1, for *** press 2,” (“***”) standing for the actions to be defined, reproducing audio file WAV, the XML source code of the modified, structured document MSD will have a structure as shown above. The structure includes, inter alia, integration of the audio file WAV “silence.wav” for suppressing TTS conversions of the individual menu items and a possibility of leaving the announcement chain when an element is selected.

A cross-reference which permits a telephone connection to a subscriber is described below. Here, a cross-reference is defined whose objective is given as dial://***, “***” standing for the number of the desired telephone subscriber. The transformation into the XML source code includes here, under certain circumstances, the addition of a script which carries out a cross-reference to a structured document SD, for example, of the type “asp” (Active Server Page), which ensures a connection setup in conjunction with a communications device (not illustrated). This structured document SD which brings about the connection setup contains, for example, TAPI instructions for the execution of the connection setup.

In the following example of three cross-references defined in the document D, a reference to the URL dial://6097346566 is assigned to the cross-reference “Vincent.” The numerical sequence “6097346566” will be assumed here to be a subscriber number of “Vincent.”

Vincent Wave Table Form

The abovementioned cross-references defined in the document D give rise to the following HTML source codes generated by Microsoft Word:

<p class=MsoNormal><a href=“dial://6097346566”>Vincent</a><a
href=“#Wave_Test”>wave</a> <a href=“#Table_Test”>table
</a> <a href=“#Form_Test”>form</a></p>

The XML source code which results after transformation of the structured document SD into the modified, structured document MSD is represented below:

<STYLE>

A.menu6
{

cue-before: To transfer to;
cue-after: Press %1;

}
A.menu7
{

cue-before: For;
cue-after: Press %1;

}

</STYLE>
<script language=“VBScript” for=“dial1” event=“onclick”>
window.navigate(“default_asp/transfer.asp?dialstring=
‘6097346566’&description=‘Vincent’&return=‘dial1_cancel’“)
</script>
<p>
<a class=“menu6” id=“dial1”href=“dial://6097346566”>Vincent
</a>
<a class=“menu7” href=“#Wave_Test”>Wave</a>
<a class=“menu7” href=“#Table_Test”>Table
</a>
<a class=“menu7” href=“#Form_Test”>form</a></p>
<a id=“dial1_cancel”></a>

The transfer of the cross-reference “Vincent” to the structured document “transfer.asp” (see above) is carried out with the arguments subscriber number as “dialstring,” the description (“Vincent”) of the cross-reference is transferred as “description.” Furthermore, a return value which permits a telephone connection to be terminated is defined.

An aspect of the SR method, that is to say voice recognition at the IVR browser WTE, will be explained below. The IVR browser WTE automatically generates lexical assignment files (not illustrated) which are known to the person skilled in the art as “Grammar Files,” and assigns them to the running application. Here, a term which is to be recognized, such as a gender designation “Male,” is assigned a number of possible expressions, for example, “Male” or “Man,” which are input vocally by the operator.

In order to improve the speech recognition, an assignment of the operator's own words to the Grammar Files is possible. This is possible, in the first instance, via a property box (not illustrated) which is reserved for this purpose, for example in the form:

Property: “IWR.inputname.grammar”

Value: “‘yes’, ‘ya’, ‘sure’”

this box containing possible inputs for a positive confirmation by the operator, and “IWR” being the name of the executing application.

Another possibility is to define possible expressions within the XML source code as shown by the following XML source code excerpt from a modified, structured document MSD for the presentation of two option boxes defined in the document D.

<P>
<label VoiceFile=“waves/silence.wav” for=“rmale”> Male
</label>
<INPUT name=“gender” id=“rmale” grammar=‘“male’, ‘man’,
‘female’, woman’“ type=“radio” value=“Male”/>
<label VoiceFile=“waves/silence.wav” for=“rfemale”> Female
</label>
<INPUT name=“gender” id=“rfemale” grammar=‘“male’, ‘man’,
‘female’, woman’“ type=“radio” value=“Female”/>
</P>

Both the TTS method and the SR method permit different languages to be set for a dialog with the user of the IVR browser WTE. For this purpose, for example a lexical analysis unit (not illustrated) is used for the TTS method for analyzing the language of information contained in the structured document SD, and a respective library file (not illustrated) is used for converting text information into speech information as a function of the detected language.

In the SR method, a respective grammar file (not illustrated) is used for converting text information into speech information as a function of the detected language of the operator at the IVR browser WTE.

If the operator of the IVR browser WTE initiates downloading of a file, for example with a file name “Example.exe,” which is stored, for example, on the WWW server SRV, progress information, for example in the form of “73% of the file Example.exe stored” with a proportion of TTS-converted data (in the example the file name “Example.exe” and the percentage “73”) are announced. The rest of the progress information can be in the form of an audio file WAV.

Although the present invention has been described with reference to specific embodiments, those of skill in the art will recognize that changes may be made thereto without departing from the spirit and scope of the invention as set forth in the hereafter appended claims.

1. A method for computer-supported transformation of a structured document into a modified, structured document which can be at least one of read and processed via an IVR browser, the method comprising the steps of:
receiving the structured document;
analyzing a source code which forms the structured document, the analysis including registering cross-references to audio files and assigning the cross-references to a first cross-reference category, and registering cross-references to one of files, regions of files and structured documents and assigning the cross-references to a second cross-reference category; and
transforming the structured document using a source code which can be read by the IVR browser, the transformation including effecting an entry which brings about a modified cross-reference to the audio file, the entry taking place in the source code for the cross-references of the first cross-reference category, and modifying the source code to define a speech-based menu structure taking into account one of a number, a format and an arrangement of the cross-references in the structured document for the cross-references of the second cross-reference category.

2. A method for computer-supported transformation of a structured document into a modified, structured document as claimed in claim 1, the method further comprising the step of:
implementing in the modified, structured document, for individual cross-references of the first cross-reference category in a text grouping, a menu structure which is to be selected from an option such that the selectable cross-reference is characterized with an acoustic characterization during a presentation of the modified, structured document.

3. A method for computer-supported transformation of a structured document into a modified, structured document as claimed in claim 1, the method further comprising the step of:
using an allocated audio file of the cross-reference, for the cross-reference of the first cross-reference category which precedes a group of cross-references of the second cross-reference category, as an explanation for the group of cross-references of the second cross-reference category for a presentation of the modified, structured document.

4. A method for computer-supported transformation of a structured document into a modified, structured document as claimed in claim 3, wherein the source code of the modified, structured document is transformed such that a presentation of the cross-reference is prohibited.

5. A method for computer-supported transformation of a structured document into a modified, structured document as claimed in claim 1, the method further comprising the step of:
supporting processing of the modified, structured document by using the IVR browser by the transformed source code via a text-to-speech conversion.

6. A method for computer-supported transformation of a structured document into a modified, structured document as claimed in claim 1, the method further comprising the step of:
supporting processing of the modified, structured document by the IVR browser by the transformed source code via a speech detection method.

7. A method for computer-supported transformation of a structured document into a modified, structured document as claimed in claim 5, the method further comprising the step of:
making reference to a library file containing a respective language in order to support different languages in the transformed source code.

8. A method for computer-supported transformation of a structured document into a modified, structured document as claimed in claim 6, the method further comprising the step of:
making reference to a library file containing a respective language in order to support different languages in the transformed source code.

9. A method for computer-supported transformation of a structured document into a modified, structured document as claimed in claim 7, wherein the library files are transmitted with the modified, structured document.

10. A method for computer-supported transformation of a structured document into a modified, structured document as claimed in claim 8, wherein the library files are transmitted with the modified, structured document.

11. A method for computer-supported transformation of a structured document into a modified, structured document as claimed in claim 1, wherein the source code of the structured document is in an HTML format.

12. A method for computer-supported transformation of a structured document into a modified, structured document as claimed in claim 1, the method further comprising the step of:
enabling an output of information of the modified, structured document both by the IVR browser and by browsers which are provided for a visual output.

13. A method for computer-supported transformation of a structured document into a modified, structured document which can be at least one of read and processed via an IVR browser, the method comprising the steps of:
receiving the structured document; and
analyzing a source code which forms the structured document, the analysis including registering cross-references to a telephone subscriber number, transforming the structured document using a source code which can be read by the IVR browser, and modifying the source code to set up and support a communications connection in conjunction with a communications device in the case of cross-references to a telephone subscriber number in the structured document.

14. A method for computer-supported transformation of a structured document into a modified, structured document as claimed in claim 13, the method further comprising the step of:
using instructions inserted into the modified, structured document to control the communications device.

15. A method for computer-supported transformation of a structured document into a modified, structured document as claimed in claim 13, wherein the support of a communications connection includes supporting power features.
